(19) United States
(12) Patent Application Publication
(10) Pub. No.: US 2024/0399873 A1
(43) Pub. Date: Dec. 5, 2024

(54) COCKPIT MODULE ASSEMBLY FOR VEHICLES

(71) Applicant: HYUNDAI MOBIS CO., LTD., Seoul (KR)

(72) Inventors: Chi Yun HAN, Yongin-si, Gyeonggi-do (KR); Ju Yeon JUNG, Yongin-si (KR)

(73) Assignee: HYUNDAI MOBIS CO., LTD., Seoul (KR)

(21) Appl. No.: 18/394,788

(22) Filed: Dec. 22, 2023

(30) Foreign Application Priority Data
Jun. 2, 2023 (KR) 10-2023-0071681
Jun. 2, 2023 (KR) 10-2023-0071682

(51) Int. Cl. B60K 37/10; B60N 3/00; B60R 7/06

(52) U.S. Cl. CPC B60K 37/10; B60N 3/001; B60R 7/06; B60K 2360/65; B60K 2360/84

(57) ABSTRACT

A cockpit module assembly for vehicles in accordance with the present disclosure includes a dashboard, an accommodation unit concavely formed in the dashboard, and a reception unit detachably mounted on the accommodation unit and including an internal space.

### CROSS-REFERENCE TO RELATED APPLICATION

This application claims the benefit under 35 U.S.C. § 119(a) of priority to Korean Patent Application No. 10-2023-0071681, filed on Jun. 2, 2023 and Korean Patent Application No. 10-2023-0071682, filed on Jun. 2, 2023 in the Korean Intellectual Property Office, the entire disclosure of which is incorporated herein by reference for all purposes.

### BACKGROUND

### Field

Exemplary embodiments of the present disclosure relate to a cockpit module assembly for vehicles.

### Discussion of the Related Art

In general, as vehicles develop, cockpit structures within vehicles tend to become increasingly diverse, and various types of cockpit modules are provided for each vehicle depending on its purpose.

The cockpit may be of a full type in which a dashboard is connected from a driver's seat to a passenger seat in a row. In the full type, the cockpit occupies the space of the passenger seat even when no one is seated in the passenger seat. Due to the size of the cockpit, it is difficult to load luggage into the passenger seat.

Due to the volume of various mechanical devices inside the cockpit, there is a problem in that it is difficult to mount a table on the cockpit. Therefore, this problem needs to be improved.

The background art of the present disclosure is disclosed in Korean Patent Application Laid-Open No. 10-2022-0163821 (published on Dec. 12, 2022 and entitled “Cockpit Module of Vehicle”).

### SUMMARY

Various embodiments are directed to a cockpit module assembly for vehicles that detachably couples a reception unit to a dashboard of a cockpit.

Various embodiments are directed to a cockpit module assembly for vehicles including a reception unit and a table unit that are mounted on a cockpit to be able to pop up.

In an embodiment, a cockpit module assembly for vehicles may include: a dashboard; an accommodation unit concavely formed in the dashboard; and a reception unit detachably mounted on the accommodation unit and including an internal space.

The accommodation unit may include: an accommodation space section concavely formed in the dashboard to accommodate the reception unit, and detachably coupled to the reception unit; and a partition wall section mounted on the dashboard to partition the accommodation space section into a plurality of parts.

The accommodation space section may include: a first accommodation space part concavely formed in the dashboard; and a second accommodation space part partitioned from the first accommodation space part by the partition wall section and concavely formed in the dashboard.

The reception unit may include: a first reception section detachably coupled to the first accommodation space part; and a second reception section detachably coupled to the second accommodation space part.

The first reception section may include: a first reception body part accommodated in the first accommodation space part; and a first reception coupling part formed on an outer surface of the first reception body part and detachably coupled to the first accommodation space part.

The first accommodation space part may be provided on an inner surface thereof with a first accommodation coupling portion formed in a “ [symbol] ” shape, and the first reception coupling part may be formed in a “┌” shape, and may be detachably coupled to the first accommodation coupling portion.

The first reception section may further include a first reception cover part rotatably coupled to the first reception body part, and configured to open and close the first reception body part.

The second reception section may include: a second reception body part accommodated in the second accommodation space part; and a second reception coupling part formed on an outer surface of the second reception body part and detachably coupled to the second accommodation space part.

The second accommodation space part may be provided on an inner surface thereof with a second accommodation coupling portion formed in a “ [symbol] ” shape, and the second reception coupling part may be formed in a “┌” shape, and may be detachably coupled to the second accommodation coupling portion.

The second reception section may further include a second reception partition part configured to partition the second reception body part.

In another embodiment, a cockpit module assembly for vehicles may include: a dashboard; a reception unit mounted on the dashboard to be able to pop up; and a table unit disposed in the dashboard to be spaced apart from the reception unit and mounted on the dashboard to be able to pop up.

The dashboard may include: a dashboard body unit; a first rail unit installed on one side of the dashboard body unit and configured to support the reception unit to be able to pop up; and a second rail unit installed on the other side of the dashboard body unit and configured to support the table unit to be able to pop up.

The reception unit may include: a reception body section mounted on the dashboard body unit to be able to pop up; a reception moving section installed in the reception body section and configured to be movable along the first rail unit; and a reception cover section configured to open and close the reception body section.

The reception moving section may be mounted on the first rail unit to be slidably movable.

At least one of one side and the other side of the reception moving section may be movably mounted on the first rail unit.

The table unit may include: a table body section mounted on the dashboard body unit to be able to pop up; and a table moving section installed on the table body section and configured to be movable along the second rail unit.

The table moving section may be mounted on the second rail unit to be slidably movable.

At least one of one side and the other side of the table moving section may be movably mounted on the second rail unit.

In accordance with a cockpit module assembly for vehicles according to the present disclosure, a reception unit may be detachably coupled to an accommodation unit concavely formed in a dashboard, so that the accommodation unit may be used in various ways depending on the purpose of use.

According to the present disclosure, the accommodation unit may be formed on a passenger seat of the dashboard of a vehicle, and the accommodation unit may be used open depending on whether a passenger is riding in the passenger seat or the reception unit may be installed, thereby improving the space utilization degree.

According to the present disclosure, by detachably coupling the reception unit to the accommodation unit, the space of the dashboard may be used in various ways, thereby reducing the cost.

According to the present disclosure, the reception unit and a table unit may be mounted to be able to pop up into a space inside a cockpit, so that the reception unit and the table unit may come out of the dashboard when necessary, thereby improving the utilization degree of a vehicle's interior space.

According to the present disclosure, the reception unit and the table unit may be able to pop up, thereby maintaining the aesthetics of a vehicle interior and improving convenience.

### BRIEF DESCRIPTION OF THE DRAWINGS

FIG. 1 is a perspective view schematically illustrating a cockpit module assembly for vehicles in accordance with an embodiment of the present disclosure.

FIG. 2 is an assembled perspective view schematically illustrating the cockpit module assembly for vehicles in accordance with an embodiment of the present disclosure.

FIG. 3 is an assembled side view schematically illustrating the cockpit module assembly for vehicles in accordance with an embodiment of the present disclosure.

FIG. 4 is an assembled perspective view schematically illustrating a state in which a first reception section is coupled to a first accommodation space part in the cockpit module assembly for vehicles in accordance with an embodiment of the present disclosure.

FIG. 5 is an assembled side view schematically illustrating a state in which the first reception section is coupled to the first accommodation space part in the cockpit module assembly for vehicles in accordance with an embodiment of the present disclosure.

FIG. 6 is an assembled perspective view schematically illustrating a state in which a second reception section is coupled to a second accommodation space part in the cockpit module assembly for vehicles in accordance with an embodiment of the present disclosure.

FIG. 7 is an assembled side view schematically illustrating a state in which the second reception section is coupled to the second accommodation space part in the cockpit module assembly for vehicles in accordance with an embodiment of the present disclosure.

FIG. 8 is a plan view schematically illustrating the cockpit module assembly for vehicles in accordance with an embodiment of the present disclosure.

FIG. 9 is a perspective view schematically illustrating a first accommodation coupling portion and coupling of the first accommodation coupling portion or a second accommodation coupling portion and coupling of the second accommodation coupling portion in the cockpit module assembly for vehicles in accordance with an embodiment of the present disclosure.

FIG. 10 is a schematic cross-sectional view taken along line A-A in FIG. 9.

FIG. 11 is a cross-sectional view schematically illustrating the first accommodation coupling portion and coupling of the first accommodation coupling portion or the second accommodation coupling portion and coupling of the second accommodation coupling portion in the cockpit module assembly for vehicles in accordance with an embodiment of the present disclosure.

FIG. 12 is a perspective view schematically illustrating a cockpit module assembly for vehicles in accordance with another embodiment of the present disclosure.

FIG. 13 is a perspective view schematically illustrating a state in which a reception unit and a table unit pop up in the cockpit module assembly for vehicles in accordance with another embodiment of the present disclosure.

FIG. 14 is a plan view schematically illustrating the cockpit module assembly for vehicles in accordance with another embodiment of the present disclosure.

FIG. 15 is a plan view schematically illustrating a state in which the reception unit and the table unit pop up in the cockpit module assembly for vehicles in accordance with another embodiment of the present disclosure.

FIG. 16 is a side view schematically illustrating the cockpit module assembly for vehicles in accordance with another embodiment of the present disclosure.

FIG. 17 is a side view schematically illustrating a state in which the reception unit and the table unit pop up in the cockpit module assembly for vehicles in accordance with another embodiment of the present disclosure.

### DETAILED DESCRIPTION

Hereinafter, a cockpit module assembly for vehicles in accordance with embodiments of the present disclosure will be described with reference to the accompanying drawings. In this process, the thicknesses of lines or the sizes of elements illustrated in the drawings may be exaggerated for the purpose of clarity and convenience of explanation.

Furthermore, terms to be described later are terms defined in consideration of functions thereof in the present disclosure and may be changed according to the intention of a user or an operator, or practice. Accordingly, such terms should be defined based on the disclosure over the present specification.

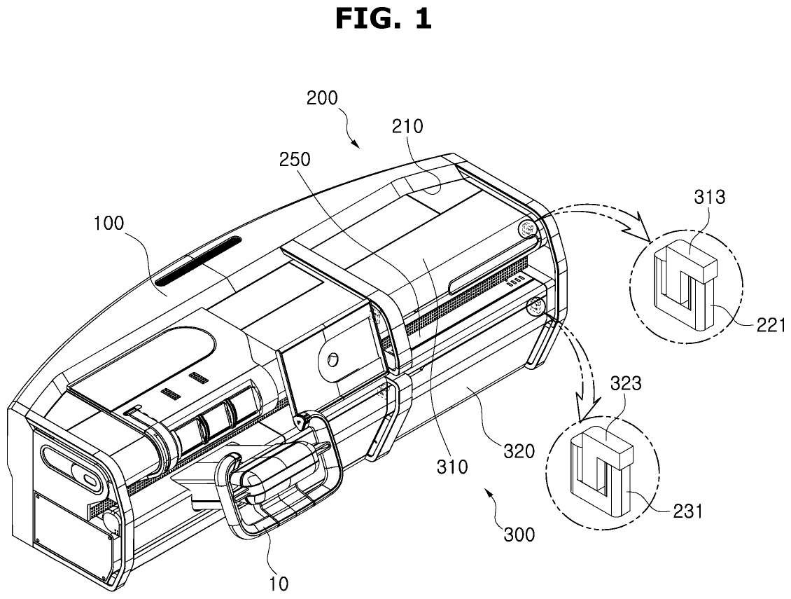

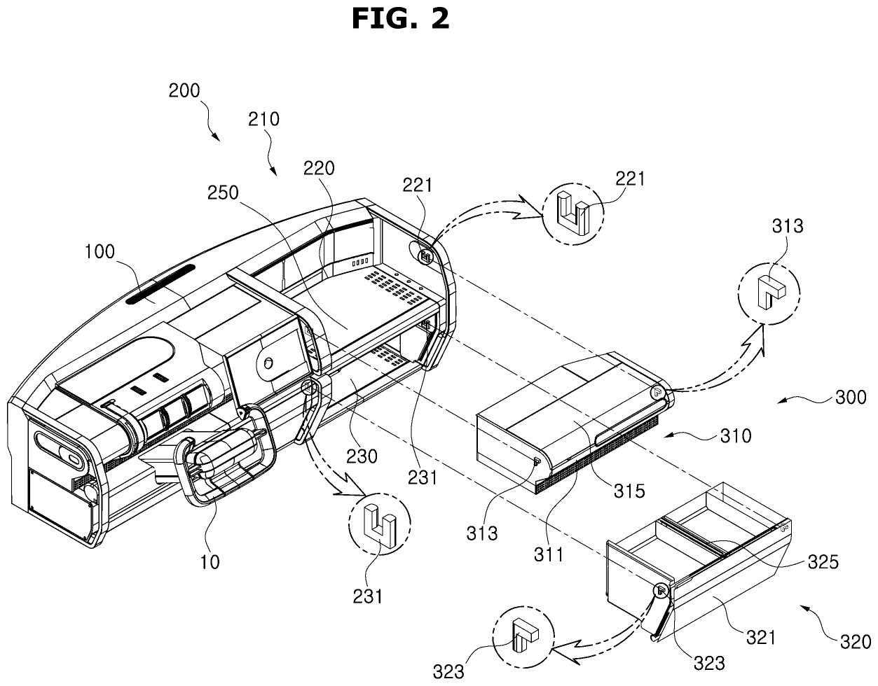

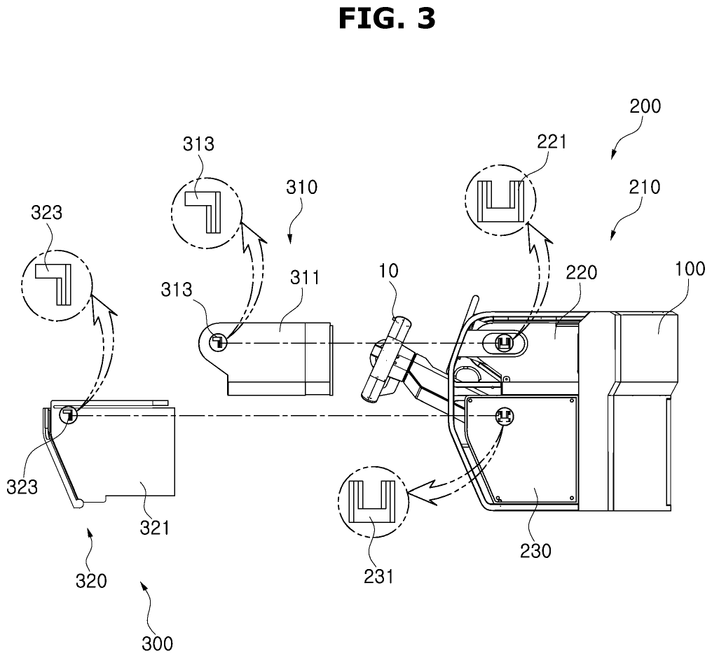

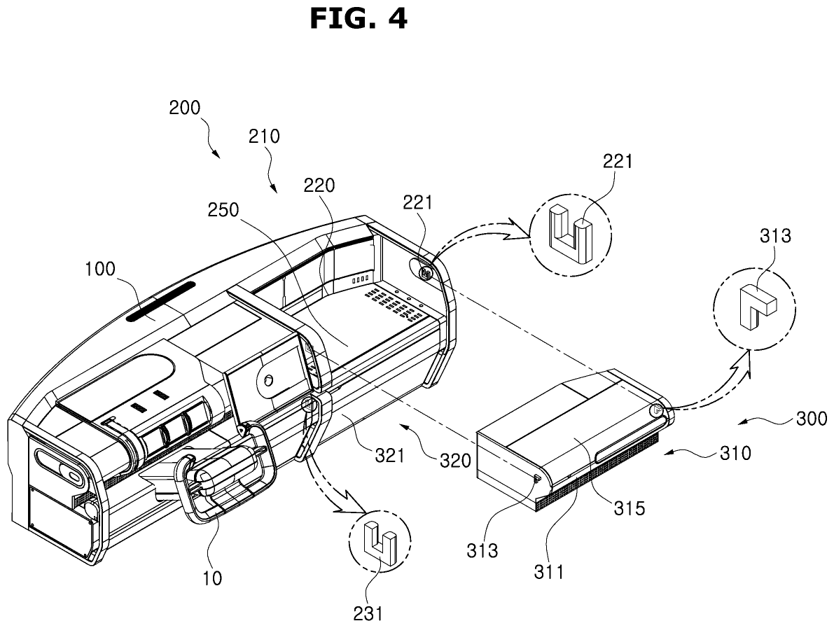

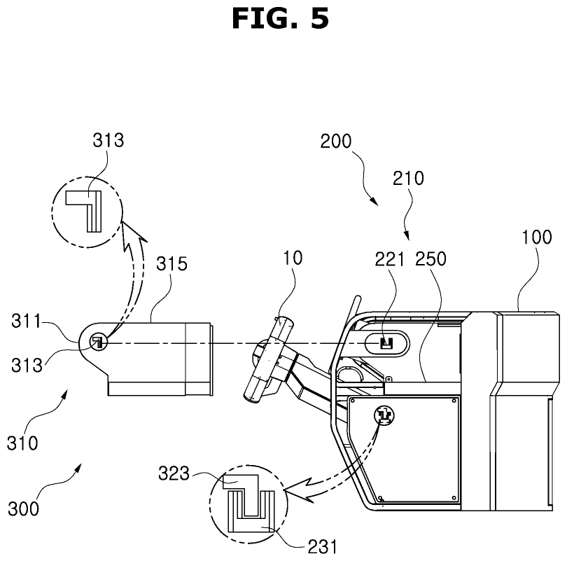

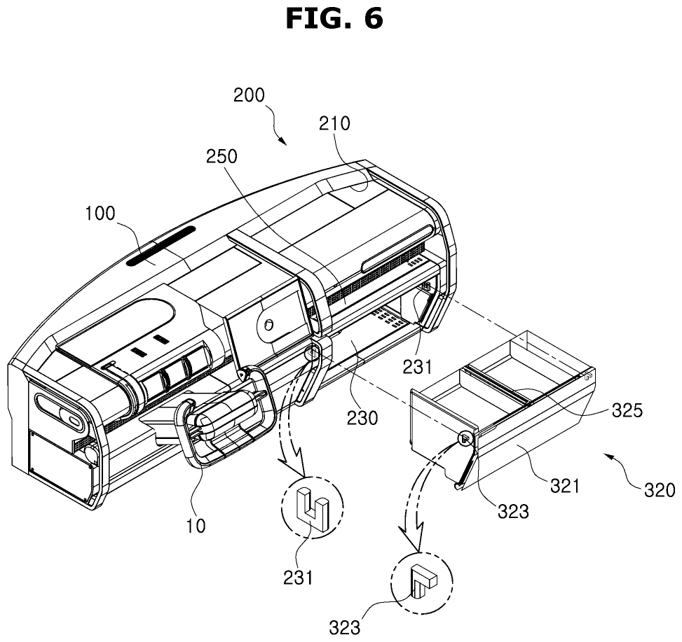

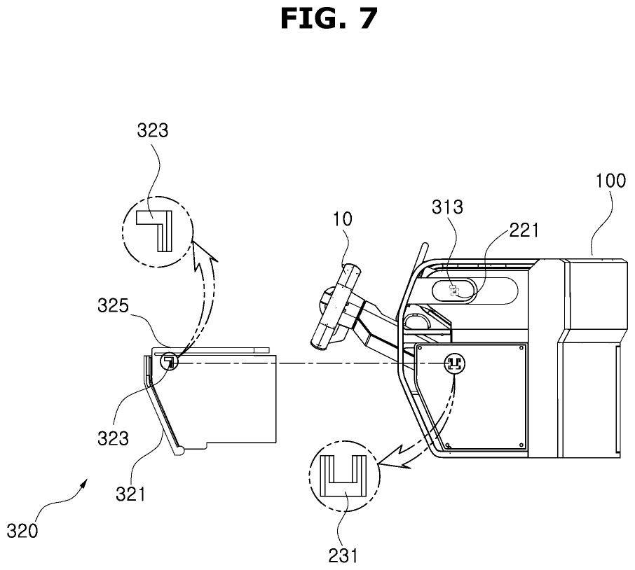

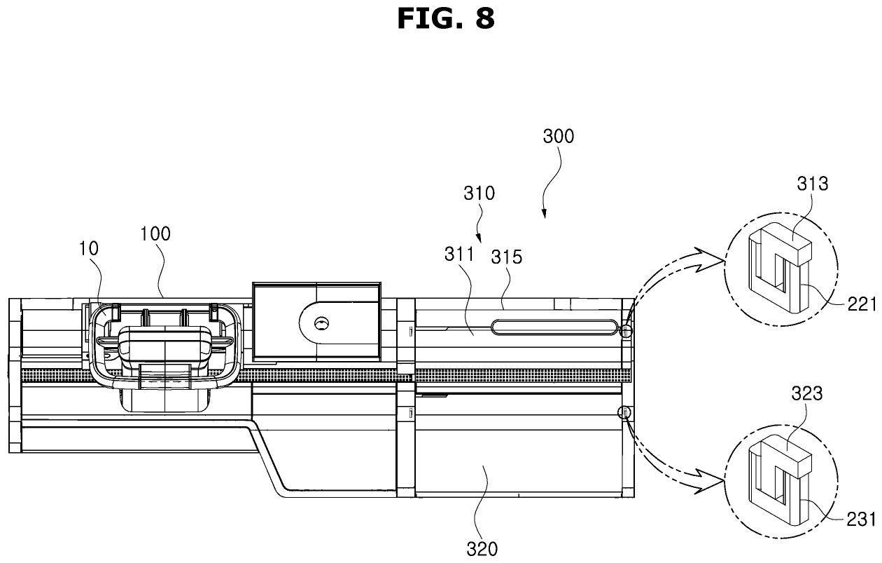

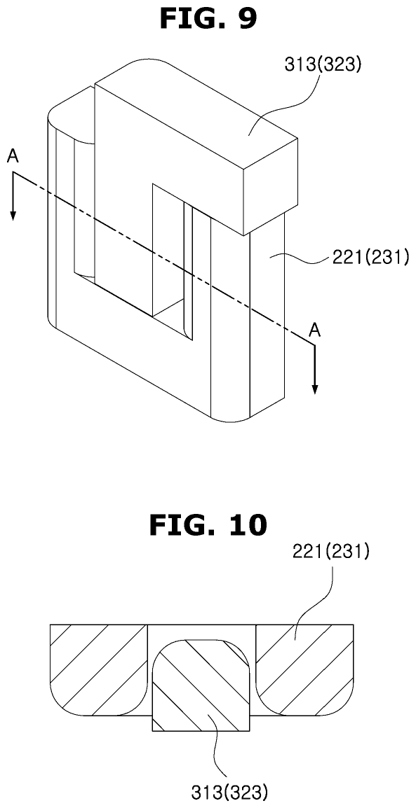

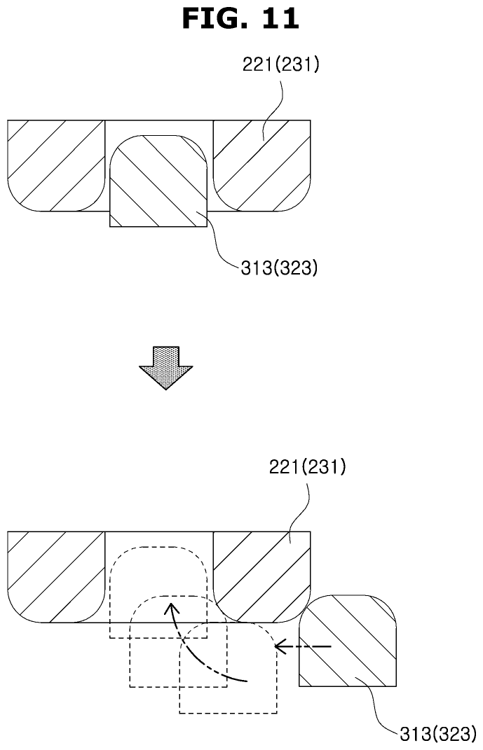

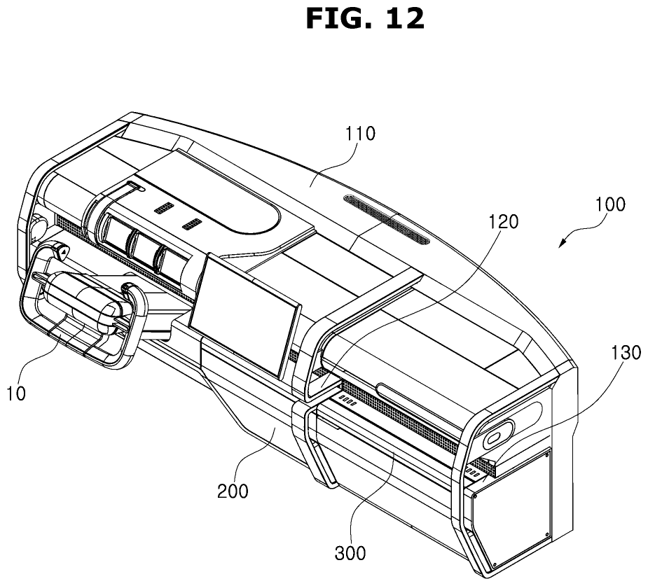

FIG. 1 is a perspective view schematically illustrating a cockpit module assembly for vehicles in accordance with an embodiment of the present disclosure, FIG. 2 is an assembled perspective view schematically illustrating the cockpit module assembly for vehicles in accordance with an embodiment of the present disclosure, FIG. 3 is an assembled side view schematically illustrating the cockpit module assembly for vehicles in accordance with an embodiment of the present disclosure, FIG. 4 is an assembled perspective view schematically illustrating a state in which a first reception section is coupled to a first accommodation space part in the cockpit module assembly for vehicles in accordance with an embodiment of the present disclosure, FIG. 5 is an assembled side view schematically illustrating a state in which the first reception section is coupled to the first accommodation space part in the cockpit module assembly for vehicles in accordance with an embodiment of the present disclosure, FIG. 6 is an assembled perspective view schematically illustrating a state in which a second reception section is coupled to a second accommodation space part in the cockpit module assembly for vehicles in accordance with an embodiment of the present disclosure, FIG. 7 is an assembled side view schematically illustrating a state in which the second reception section is coupled to the second accommodation space part in the cockpit module assembly for vehicles in accordance with an embodiment of the present disclosure, FIG. 8 is a plan view schematically illustrating the cockpit module assembly for vehicles in accordance with an embodiment of the present disclosure, FIG. 9 is a perspective view schematically illustrating a first accommodation coupling portion and coupling of the first accommodation coupling portion or a second accommodation coupling portion and coupling of the second accommodation coupling portion in the cockpit module assembly for vehicles in accordance with an embodiment of the present disclosure, FIG. 10 is a schematic cross-sectional view taken along line A-A in FIG. 9, and FIG. 11 is a cross-sectional view schematically illustrating the first accommodation coupling portion and coupling of the first accommodation coupling portion or the second accommodation coupling portion and coupling of the second accommodation coupling portion in the cockpit module assembly for vehicles in accordance with an embodiment of the present disclosure.

Referring to FIGS. 1 to 11, a cockpit module assembly for vehicles in accordance with an embodiment of the present disclosure may include a dashboard 100, an accommodation unit 200, and a reception unit 300.

The dashboard 100 may be equipped with various instruments and devices necessary for driving on a driver's seat (left side in FIG. 1) and a passenger seat (right side in FIG. 1) in mobility vehicles such as vehicles. The driver's seat may refer to a location where a steering wheel 10 is mounted. The steering wheel 10 may be rotatably mounted on the dashboard 100 and may steer the rotation of a vehicle according to a rotation direction.

The passenger seat may refer to an opposite side of the driver's seat (right side in FIG. 1), and refer to a position where the steering wheel 10 is not disposed.

The dashboard 100 may be divided by a partition wall between the driver's seat and the passenger seat (half type). Alternatively, the dashboard 100 may be formed from the driver's seat to the passenger seat in a row (from left to right in FIG. 1) (full type).

The accommodation unit 200 may be concavely formed in the dashboard 100. The accommodation unit 200 may be concavely formed on the passenger seat side of the dashboard 100. The reception unit 300 may be detachably mounted on the accommodation unit 200.

The accommodation unit 200 may include an accommodation space section 210 and a partition wall section 250. The accommodation space section 210 may be concavely formed in the dashboard 100 to accommodate the reception unit 300, and may be detachably coupled to the reception unit 300. The accommodation unit 200 may be partitioned into a plurality of parts by the partition wall section 250.

The partition wall section 250 may be mounted on the dashboard 100 to partition the accommodation space section 210 into a plurality of parts. The partition wall section 250 may be detachably mounted on the dashboard 100, and may be mounted on the dashboard 100 according to user's needs.

The partition wall section 250 may be mounted on the dashboard 100 to partition the accommodation space section 210 into a plurality of parts, or may be separated from the dashboard 100. The partition wall section 250 may be detachably coupled to the dashboard 100, thereby improving the space utilization degree of the accommodation space section 210.

The drawings of the present disclosure illustrate that one partition wall section 250 is mounted on the dashboard 100 to partition the accommodation space section 210 into two parts; however, the present disclosure is not limited thereto and the number and the mounting position can be changed. The partition wall section 250 may partition the accommodation space section 210 vertically and horizontally.

The following will be described as an example in which the accommodation space section 210 is vertically partitioned into two parts by one partition wall section 250.

The accommodation space section 210 may include a first accommodation space part 220 and a second accommodation space part 230. The first accommodation space part 220 may be concavely formed in the dashboard 100. The first accommodation space part 220 may be partitioned from the second accommodation space part 230 by the partition wall section 250. The first accommodation space part 220 may be vertically partitioned from the second accommodation space part 230 by the partition wall section 250 horizontally disposed.

The first accommodation space part 220 may be provided on an inner surface thereof with a first accommodation coupling portion 221 formed in a “ [symbol] ” shape. The “ [symbol] ” shape is a U shape with a flat bottom. The first accommodation coupling portion 221 of the first accommodation space part 220 may be detachably coupled to a first reception coupling part 313 of a first reception section 310. The first accommodation coupling portion 221 may be formed on both sides of the inner surface of the first accommodation space part 220.

The second accommodation space part 230 may be concavely formed in the dashboard 100. The first accommodation space part 220 may be partitioned from the second accommodation space part 230 by the partition wall section 250. The first accommodation space part 220 may be vertically partitioned from the second accommodation space part 230 by the partition wall section 250 horizontally disposed.

The second accommodation space part 230 may be partitioned from the first accommodation space part 220 by the partition wall section 250. The second accommodation space part 230 may be concavely formed in the dashboard 100.

The second accommodation space part 230 may be provided on an inner surface thereof with a second accommodation coupling portion 231 formed in a “ [symbol] ” shape. The second accommodation coupling portion 231 of the second accommodation space part 230 may be detachably coupled to a second reception coupling part 323 of a second reception section 320. The second accommodation coupling portion 231 may be formed on both sides of the inner surface of the second accommodation space part 230.

The reception unit 300 may be detachably mounted on the accommodation unit 200 and may have an internal space. The reception unit 300 may have the internal space and receive various items in the internal space. The reception unit 300 may be detachably mounted on the accommodation unit 200, thereby improving the space utilization degree of the accommodation unit 200.

The reception unit 300 may include the first reception section 310 and the second reception section 320. The number of reception units 300 may increase or decrease depending on the number of accommodation units 200.

The first reception section 310 may be detachably coupled to the first accommodation space part 220. The first reception section 310 may include a first reception body part 311 and a first reception coupling part 313. The first reception body part 311 may be accommodated in the first accommodation space part 220.

The first reception coupling part 313 may be formed on an outer surface of the first reception body part 311, and may be detachably coupled to the first accommodation space part 220. The first reception coupling part 313 may be formed on the outer surface of the first reception body part 311 at a position corresponding to the first accommodation coupling portion 221 of the first accommodation space part 220.

The first reception coupling part 313 may be formed in a “┌” shape, and may be detachably coupled to the first accommodation coupling portion 221. The “┌” shape is a rod shape with one end bent at a right angle. The first reception coupling part 313 formed in a “┌” shape may be detachably coupled to the first accommodation coupling portion 221 formed in a “ [symbol] ” shape.

The first reception coupling part 313 and the first accommodation coupling portion 221 may be formed to have rounded outer surfaces, so that when the first reception coupling part 313 is mounted on the first accommodation coupling portion 221, the first reception coupling part 313 may be inserted and mounted into the rounded first accommodation coupling portion 221 while being elastically deformed (see FIGS. 9 to 11).

The first reception section 310 may further include a first reception cover part 315. The first reception cover part 315 may be rotatably coupled to the first reception body part 311, and may open and close the first reception body part 311. The first reception cover part 315 may be rotatably coupled to the first reception body part 311, and may be hinged to the first reception body part 311. The first reception cover part 315 may be rotatably coupled to the first reception body part 311, thereby blocking foreign substances and the like from entering the first reception body part 311.

The second reception section 320 may be detachably coupled to the second accommodation space part 230. The second reception section 320 may include a second reception body part 321 and a second reception coupling part 323. The second reception body part 321 may be accommodated in the second accommodation space part 230. The second reception body part 321 opened upward may be covered by the partition wall section 250.

The second reception coupling part 323 may be formed on an outer surface of the second reception body part 321, and may be detachably coupled to the second accommodation space part 230. The second reception coupling part 323 may be formed on the outer surface of the second reception body part 321 at a position corresponding to the second accommodation coupling portion 231 of the second accommodation space part 230.

The second reception coupling part 323 may be formed in a “┌” shape, and may be detachably coupled to the second accommodation coupling portion 231. The second reception coupling part 323 formed in the “┌” shape may be detachably coupled to the second accommodation coupling portion 231 formed in the “ [symbol] ” shape.

The second reception coupling part 323 and the second accommodation coupling portion 231 may be formed to have rounded outer surfaces, so that when the second reception coupling part 323 is mounted on the second accommodation coupling portion 231, the second reception coupling part 323 may be inserted and mounted into the rounded second accommodation coupling portion 231 while being elastically deformed (see FIGS. 9 to 11).

The second reception section 320 may further include a second reception partition part 325. The second reception partition part 325 may partition the internal space of the second reception body part 321. The second reception partition part 325 may change the size of the internal space of the second reception body part 321 by changing a position where the second reception partition part 325 is mounted in the internal space of the second reception body part 321. The second reception partition part 325 may be detachably mounted on the second reception body part 321.

In accordance with the cockpit module assembly for vehicles according to the present disclosure, the reception unit 300 may be detachably coupled to the accommodation unit 200 concavely formed in the dashboard 100, so that the accommodation unit 200 may be used in various ways depending on the purpose of use.

According to the present disclosure, the accommodation unit 200 may be formed on a passenger seat of the dashboard 100 of a vehicle, and the accommodation unit 200 may be used open depending on whether a passenger is riding in the passenger seat or the reception unit 300 may be installed, thereby improving the space utilization degree.

According to the present disclosure, by detachably coupling the reception unit 300 to the accommodation unit 200, the space of the dashboard 100 may be used in various ways, thereby reducing the cost.

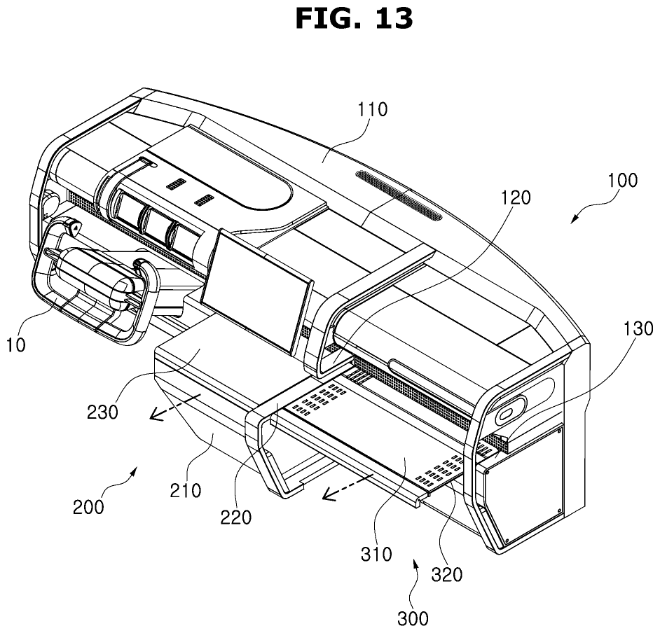

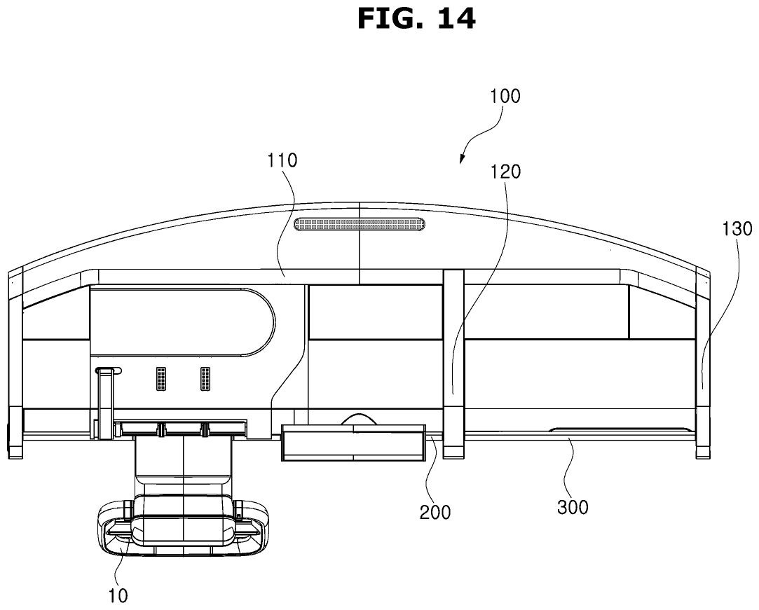

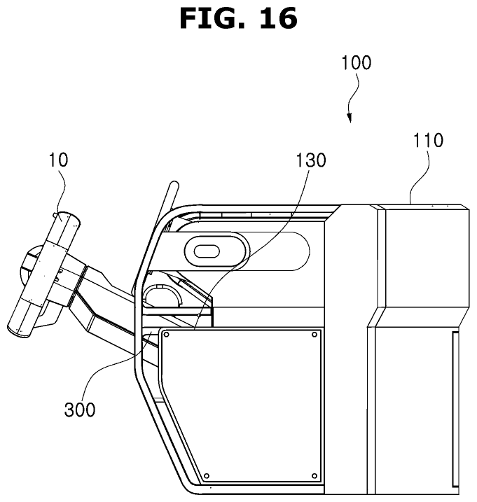

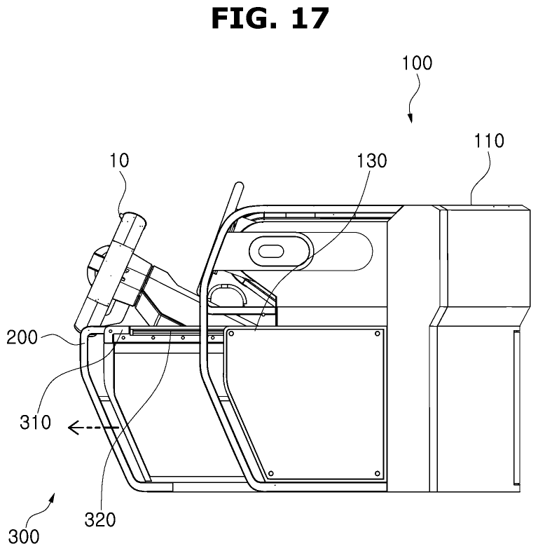

FIG. 12 is a perspective view schematically illustrating a cockpit module assembly for vehicles in accordance with another embodiment of the present disclosure, FIG. 13 is a perspective view schematically illustrating a state in which a reception unit and a table unit pop up in the cockpit module assembly for vehicles in accordance with another embodiment of the present disclosure, FIG. 14 is a plan view schematically illustrating the cockpit module assembly for vehicles in accordance with another embodiment of the present disclosure, FIG. is a plan view schematically illustrating a state in which the reception unit and the table unit pop up in the cockpit module assembly for vehicles in accordance with another embodiment of the present disclosure, FIG. 16 is a side view schematically illustrating the cockpit module assembly for vehicles in accordance with another embodiment of the present disclosure, and FIG. 17 is a side view schematically illustrating a state in which the reception unit and the table unit pop up in the cockpit module assembly for vehicles in accordance with another embodiment of the present disclosure.

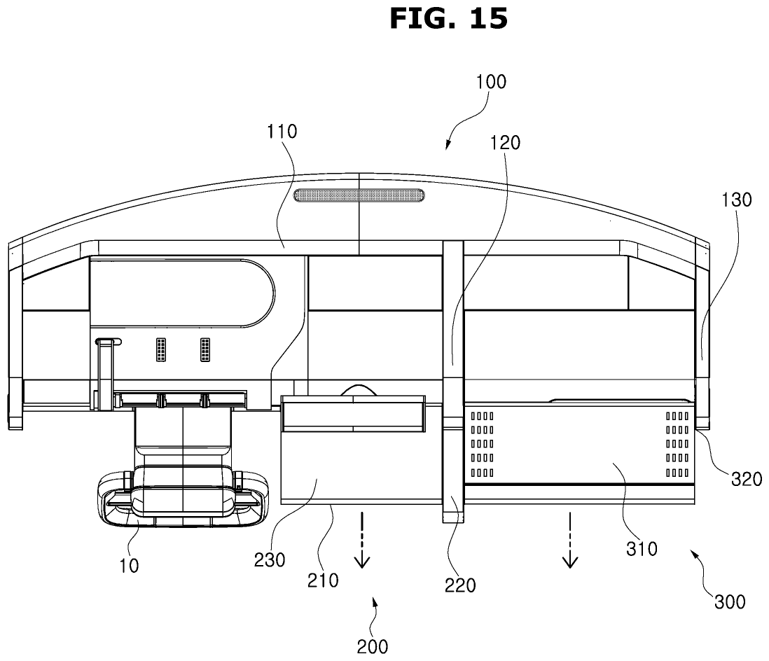

Referring to FIGS. 12 to 17, a cockpit module assembly for vehicles in accordance with another embodiment of the present disclosure may include a dashboard 100, a reception unit 200, and a table unit 300.

The dashboard 100 may be equipped with various instruments and devices necessary for driving on a driver's seat (left in FIG. 12) and a passenger seat (right in FIG. 12) in mobility vehicles such as vehicles. The dashboard 100 may be divided by a partition wall between the driver's seat and the passenger seat (half type). Alternatively, the dashboard 100 may be formed from the driver's seat to the passenger seat in a row (from left to right in FIG. 12) (full type).

A steering wheel 10 may be installed on the driver's seat side of the dashboard 100 to steer a vehicle when turning left or right.

The dashboard 100 may include a dashboard body unit 110, a first rail unit 120, and a second rail unit 130. The dashboard body unit 110 may be equipped with various instruments and devices necessary for driving on the driver's seat (left in FIG. 12) and the passenger seat (right in FIG. 12) in mobility vehicles such as vehicles. The dashboard 100 may be divided by a partition between the driver's seat and the passenger seat (half type). Alternatively, the dashboard 100 may be formed from the driver's seat to the passenger seat in a row (from left to right in FIG. 12) (full type). The steering wheel 10 may be rotatably mounted on the dashboard body unit 110.

The first rail unit 120 may be installed on one side of the dashboard body unit 110 (intermediate side of the dashboard body unit 110 in FIG. 13), and may support the reception unit 200 to be able to pop up. The first rail unit 120 may guide the reception unit 200 so that the reception unit 200 may pop up in a front-rear direction of a vehicle (left-right direction in FIG. 17).

The first rail unit 120 may movably guide a reception moving section 220 of the reception unit 200. The first rail unit 120 may movably support at least one of one side (upper side in FIG. 13) or the other side (lower side in FIG. 13) of the reception moving section 220.

The second rail unit 130 may be installed on the other side of the dashboard body unit 110 (right side of the dashboard body unit 110 in FIG. 13), and may support the table unit 300 to be able to pop up. The second rail unit 130 may guide the table unit 300 so that the table unit 300 may pop up in the front-rear direction of the vehicle (left-right direction in FIG. 17).

The second rail unit 130 may movably guide a table moving section 320 of the table unit 300. The second rail unit 130 may movably support at least one of one side (upper side in FIG. 13) or the other side (lower side in FIG. 13) of the table moving section 320.

The reception unit 200 may be mounted on the dashboard 100 to be able to pop up. The reception unit 200 may pop up from the dashboard body unit 110 of the dashboard 100 along the first rail unit 120.

The reception unit 200 may include a reception body section 210, the reception moving section 220, and a reception cover section 230. The reception body section 210 may be mounted on the dashboard body unit 110 to be able to pop up. The reception body section 210 may be formed opened upward to receive items and the like in an internal space thereof.

The open surface of the reception body section 210 may be opened and closed by the reception cover section 230. The reception body section 210 may be mounted on the dashboard body unit 110 to be able to pop up, so that the reception body section 210 comes out of the dashboard 100 when necessary, thereby improving the utilization degree of the vehicle's interior space.

The reception moving section 220 may be installed in the reception body section 210, and may be movable along the first rail unit 120. The reception moving section 220 may be formed in the reception body section 210 to surround an edge of the first rail unit 120. The reception moving section 220 may be formed to surround the edge of the first rail unit 120, and may be mounted on the first rail unit 120 to be slidably movable along a longitudinal direction of the first rail unit 120.

At least one of one side (upper side in FIG. 13) and the other side (lower side in FIG. 13) of the reception moving section 220 may be movably mounted on the first rail unit 120. At least one of one side (upper side in FIG. 13) and the other side (lower side in FIG. 13) of the reception moving section 220 may be movably mounted on the first rail unit 120, and may be mounted by changing an installation position of the reception moving section 220 on the first rail unit 120 when necessary.

The reception cover section 230 may open and close the reception body section 210. The reception cover section 230 may be rotatably mounted on an upper surface of the reception body section 210. The reception cover section 230 may be hinged to the reception body section 210. The reception cover section 230 may be hinged to the reception body section 210, and may be rotated to open and close the opened upper surface of the reception body section 210.

The table unit 300 may be disposed on the dashboard 100 to be spaced apart from the reception unit 200, and may be mounted on the dashboard 100 to be able to pop up. The table unit 300 may be disposed on the dashboard body unit 110 of the dashboard 100 to be spaced apart from the reception unit 200, and may pop up from the dashboard body unit 110 of the dashboard 100 along the second rail unit 130.

The table unit 300 may include a table body section 310 and the table moving section 320. The table body section 310 may be mounted on the dashboard body unit 110 to be able to pop up. The table body section 310 may be formed in the form of a flat plate, and may be disposed on the dashboard body unit 110 to be spaced apart from the reception unit 200. The table body section 310 may be formed in the form of a flat plate, so that items and the like may be placed on an upper surface of the table body section 310.

The table moving section 320 may be installed on the table body section 310, and may be movable along the second rail unit 130. The table moving section 320 may be formed on the table body section 310 to surround an edge of the second rail unit 130. The table moving section 320 may be formed to surround the edge of the second rail unit 130, and may be mounted on the second rail unit 130 to be slidably movable along a longitudinal direction of the second rail unit 130.

At least one of one side (upper side in FIG. 13) and the other side (lower side in FIG. 13) of the table moving section 320 may be movably mounted on the second rail unit 130. At least one of the one side (upper side in FIG. 13) and the other side (lower side in FIG. 13) of the table moving section 320 may be movably mounted on the second rail unit 130, and may be mounted by changing an installation position of the table moving section 320 on the second rail unit 130 when necessary.

In accordance with a cockpit module assembly for vehicles according to the present disclosure, the reception unit 200 and the table unit 300 may be mounted to be able to pop up into a space inside a cockpit, so that the reception unit 200 and the table unit 300 may come out of the dashboard 100 when necessary, thereby improving the utilization degree of a vehicle's interior space.

According to the present disclosure, the reception unit 200 and the table unit 300 may be able to pop up, thereby maintaining the aesthetics of a vehicle interior and improving convenience.

Although the present disclosure has been described with reference to the embodiments illustrated in the drawings, the embodiments of the disclosure are for illustrative purposes only, and those skilled in the art will appreciate that various modifications and other equivalent embodiments are possible from the embodiments. Thus, the true technical scope of the present disclosure should be defined by the following claims.

What is claimed is:

1. A cockpit module assembly for vehicles comprising:
a dashboard;
an accommodation unit concavely formed in the dashboard; and
a reception unit detachably mounted on the accommodation unit and including an internal space.

2. The cockpit module assembly for vehicles according to claim 1, wherein the accommodation unit comprises:
an accommodation space section concavely formed in the dashboard to accommodate the reception unit, and detachably coupled to the reception unit; and
a partition wall section mounted on the dashboard to partition the accommodation space section into a plurality of parts.

3. The cockpit module assembly for vehicles according to claim 2, wherein the accommodation space section comprises:
a first accommodation space part concavely formed in the dashboard; and
a second accommodation space part concavely formed in the dashboard.

4. The cockpit module assembly for vehicles according to claim 3, wherein the reception unit comprises:
a first reception section detachably coupled to the first accommodation space part; and
a second reception section detachably coupled to the second accommodation space part.

5. The cockpit module assembly for vehicles according to claim 4, wherein the first reception section comprises:
a first reception body part accommodated in the first accommodation space part; and
a first reception coupling part formed on an outer surface of the first reception body part and detachably coupled to the first accommodation space part.

6. The cockpit module assembly for vehicles according to claim 5, wherein the first accommodation space part is provided on an inner surface thereof with a first accommodation coupling portion formed in in a U shape with a flat bottom, and
the first reception coupling part is formed in a rod shape with one end bent at a right angle, and is detachably coupled to the first accommodation coupling portion.

7. The cockpit module assembly for vehicles according to claim 5, wherein the first reception section further comprises:
a first reception cover part rotatably coupled to the first reception body part, and configured to open and close the first reception body part.

8. The cockpit module assembly for vehicles according to claim 4, wherein the second reception section comprises:
a second reception body part accommodated in the second accommodation space part; and
a second reception coupling part formed on an outer surface of the second reception body part and detachably coupled to the second accommodation space part.

9. The cockpit module assembly for vehicles according to claim 8, wherein the second accommodation space part is provided on an inner surface thereof with a second accommodation coupling portion formed in a U shape with a flat bottom, and
the second reception coupling part is formed in a rod shape with one end bent at a right angle, and is detachably coupled to the second accommodation coupling portion.

10. The cockpit module assembly for vehicles according to claim 8, wherein the second reception section further comprises:
a second reception partition part configured to partition the second reception body part.

11. A cockpit module assembly for vehicles comprising:
a dashboard;
a reception unit mounted on the dashboard to be able to pop up; and
a table unit disposed in the dashboard to be spaced apart from the reception unit and mounted on the dashboard to be able to pop up.

12. The cockpit module assembly for vehicles according to claim 11, wherein the dashboard comprises:
a dashboard body unit;
a first rail unit installed on one side of the dashboard body unit and configured to support the reception unit to be able to pop up; and
a second rail unit installed on the other side of the dashboard body unit and configured to support the table unit to be able to pop up.

13. The cockpit module assembly for vehicles according to claim 12, wherein the reception unit comprises:
a reception body section mounted on the dashboard body unit to be able to pop up;
a reception moving section installed in the reception body section and configured to be movable along the first rail unit; and
a reception cover section configured to open and close the reception body section.

14. The cockpit module assembly for vehicles according to claim 13, wherein the reception moving section is mounted on the first rail unit to be slidably movable.

15. The cockpit module assembly for vehicles according to claim 13, wherein at least one of one side and the other side of the reception moving section is movably mounted on the first rail unit.

16. The cockpit module assembly for vehicles according to claim 12, wherein the table unit comprises:
a table body section mounted on the dashboard body unit to be able to pop up; and
a table moving section installed on the table body section and configured to be movable along the second rail unit.

17. The cockpit module assembly for vehicles according to claim 16, wherein the table moving section is mounted on the second rail unit to be slidably movable.

18. The cockpit module assembly for vehicles according to claim 16, wherein at least one of one side and the other side of the table moving section is movably mounted on the second rail unit.
